(19) United States
(12) Patent Application Publication
(10) Pub. No.: US 2009/0308626 A1
(43) Pub. Date: Dec. 17, 2009

(54) ELECTRIC HAND TOOL

(76) Inventor: Dietmar Saur, Gomaringen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/306,337

(22) PCT Filed: May 4, 2007
(86) PCT No.: PCT/EP07/54364

§ 371 Date: Dec. 23, 2008

(30) Foreign Application Priority Data
Jun. 27, 2006 (DE) 102006029363.0

(51) Int. Cl. B25D 16/00; B23B 45/16; B25D 11/06

(52) U.S. Cl. 173/48; 173/47; 173/160

(57) ABSTRACT

The invention is an electric hand tool embodied as a hammer drill and/or slide hammer, with a work spindle, a striking tool, and an electric drive motor which can be connected to an intermediate shaft driving the work spindle and/or to a striking tool drive, via a transmission and coupling device. The transmission and coupling device have a transmission, and the transmission is-a multi-stage spur gear mechanism, the gears of which are shifted by axial displacement of the intermediate shaft.

The invention relates to an electric hand tool embodied in the form of a rotary and/or percussion hammer, equipped with a working spindle, an impact mechanism, and an electric drive motor that a transmission/clutch unit is able to connect to an intermediate shaft that drives the working spindle and/or to an impact mechanism drive unit; the transmission/clutch unit includes a transmission.

### PRIOR ART

A rotary and/or percussion hammer can be used in an extremely wide variety of applications. The main uses are hammer drilling (percussion drilling) and chiseling (without rotary drive). Electric hand tools of this kind are also used in the application fields rotary hammering machines, percussion drilling machines, or screwdrivers. The products depend on the main area of use. There is a wide variance in cutting speeds for drilling concrete, wood, steel, nonferrous medals, or plastics, i.e. these require appropriate speeds. When drilling into stone, the working spindle speed must be selected to be significantly lower than when drilling into wood and steel. The speed also depends on the cooling medium and on the material of the drill bit cutting edge. There are also uses in which a fast working spindle speed is required, for example when stirring. The rotary and/or percussion hammers known from the prior art are not particularly suitable for the variety of different intended uses mentioned here or can only be used to a limited degree for them. Since rotary and/or percussion hammers are becoming ever more power-dense, i.e. more compactly built, these electric hand tools are also suitable, with regard to their ergonomics, for use in the field of drilling machines.

### DISCLOSURE OF THE INVENTION

The electric hand tool according to the invention, which is embodied in the form of a rotary and/or percussion hammer of the kind described at the beginning, should be usable in a wide variety of ways. The original application field of such electric hand tools should be broadened and optimized for the respective intended uses. To this end, the transmission is embodied in the form of a multistage spur gear transmission whose gears are shifted through axial movement the intermediate shaft. This design type yields a small, manageable size and, through the provision of the multistage spur gear transmission, permits the seating of various working spindle speeds so that there is at least one speed for a drilling/percussion drilling and at least one other, faster speed, in particular for high-speed drilling. The gear shifting through axial movement of the intermediate shaft achieves a simple, compact design that assures a reliable function.

According to a modification of the invention, the intermediate shaft is associated with at least two different-diameter spur gears of the spur gear transmission so that the spur gears maintain their axial position during the axial movement of the intermediate shaft. With regard to their axial placement, the spur gears are thus situated in a stationary fashion inside the housing of the electric hand tool; they do not leave this axial position even when the intermediate shaft is moved in the axial direction in order to carry out a change of the operating mode. A “change of operating mode” is understood to mean both a speed change of the working spindle and in particular, a change from, for example, a pure drilling operation to a percussion drilling operation or a pure chiseling operation.

According to a modification of the invention, the intermediate shaft has a driver profile that in different axial positions of the intermediate shaft, is coupled in a rotationally fixed fashion to a respective counterpart driver profile of the one or the other spur gear or is coupled to neither of the spur gears. Depending on the axial position of the intermediate shaft, therefore, the one or the other spur gear is activated, yielding different working spindle speeds. If the intermediate shaft, through its corresponding axial position, is decoupled from the spur gears, then this can be used, for example, to carry out the chiseling operation in which the tool is only acted on with percussion and is not rotated.

It is also advantageous if a rotational securing device for the intermediate shaft is provided, which rotationally locks the intermediate shaft in its corresponding axial movement setting. This operating mode, also referred to as “Vario-Lock” mode, permits the insert tool to be positioned with a fixed rotation angle for chiseling. Consequently, the Vario-Lock setting is used for the positioning of the insert tool. The insert tool is supported so that it is able to rotate around the rotation axis of the hammer since there is no form-locking engagement with the drive train. In the chiseling mode, the Vario-Lock prevents the insert tool from rotating.

Finally, it is advantageous if the electric hand tool is embodied in a pistol design in which a drive shaft of the drive motor is situated extending parallel to the working spindle.

### BRIEF DESCRIPTION OF THE DRAWINGS

The drawings illustrate the invention by means of an exemplary embodiment.

FIG. 1 is a side view of the electric hand tool embodied in the form of a rotary and/or percussion hammer,

FIGS. 2a through e shows various settings of an operating mode selector switch of the electric hand tool from FIG. 1,

FIG. 3 shows an inner region of the electric hand tool from FIG. 1,

FIGS. 4 through 7 show various positions of functional groups of the electric hand tool from FIG. 1 for producing different operating modes.

### EMBODIMENT(S) OF THE INVENTION

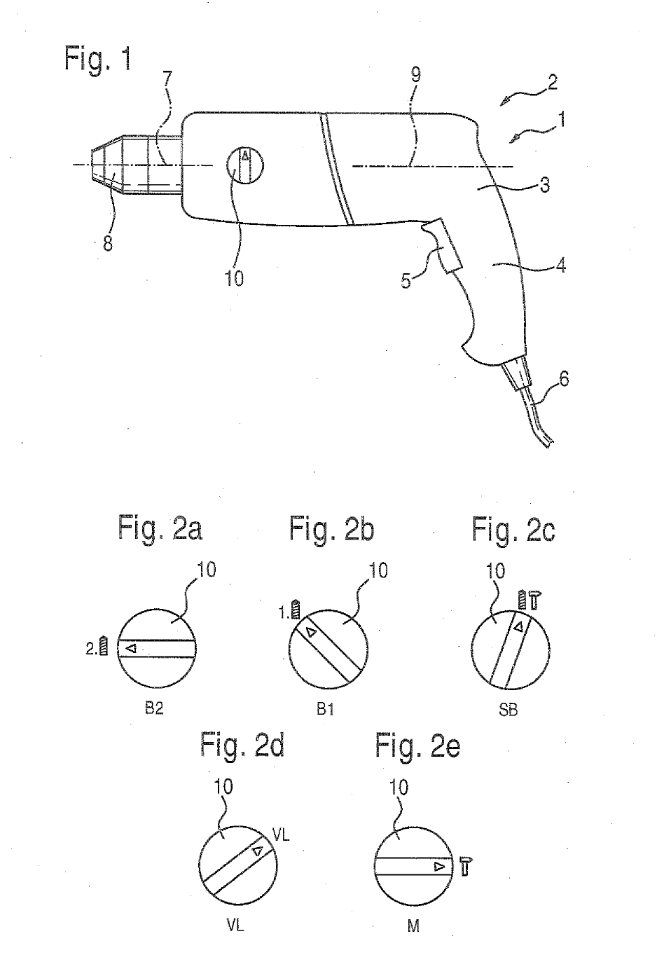

FIG. 1 shows an electric hand tool 1, which is embodied in the form of a rotary and/or percussion hammer 2. The electric hand tool 1 has a housing 3 with a grip 4; the grip 4 is provided with an on/off switch 5. An electric drive motor is supplied with electrical energy via a power cord 6. A tool socket 8 for a tool such as a drill bit is situated on a working spindle (rotation axis 7). The above-mentioned electric drive motor has a drive shaft with the rotation axis 9; the rotation axis 9 extends parallel to the rotation axis 7 so that the electric hand tool 1 is correspondingly embodied in a pistol design.

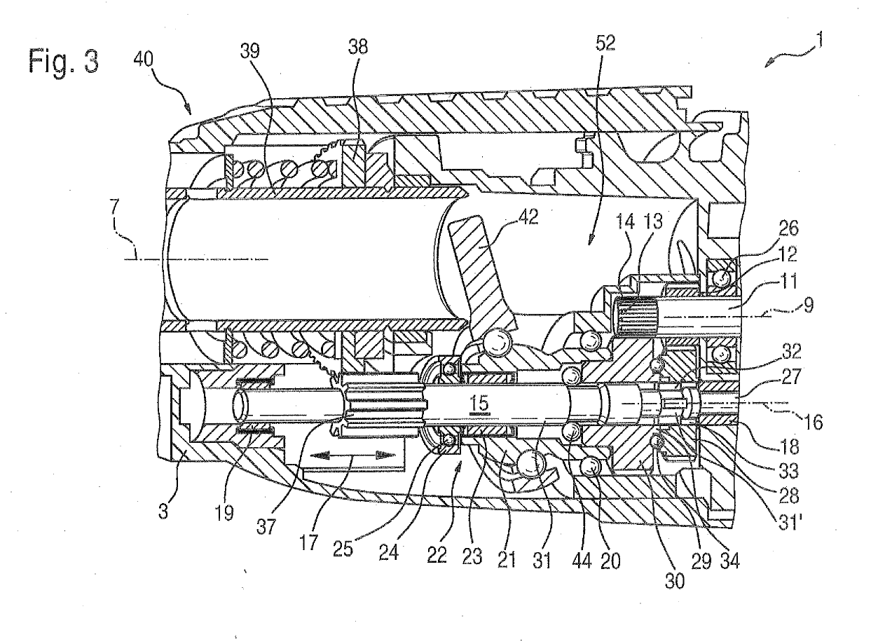

Mounted on the housing 3 is an operating mode selector switch 10 with which different operating modes of the electric hand tool 1 can be selected, as shown in FIGS. 2a through 2e. This is done by rotating the operating mode selector switch 10. FIG. 2a identifies a drilling mode in a second gear with the label B2 and a drill bit symbol, accompanied by the additional indication “2^{nd}”. FIG. 2b identifies a drilling mode in a first gear with the label B1 and a drill bit symbol, accompanied by the additional indication “1^{st}”. FIG. 2c identifies a position of the operating mode selector switch 10 in which a percussion drilling operation is carried out. This is indicated by the label SB and represented by a drill bit symbol and a hammer symbol. FIG. 2d shows a Vario-Lock mode, which is labeled VL. Finally, FIG. 2e shows the operating mode selector switch 10 in a position in which a pure chiseling operation M is carried out, which is indicated by a hammer.

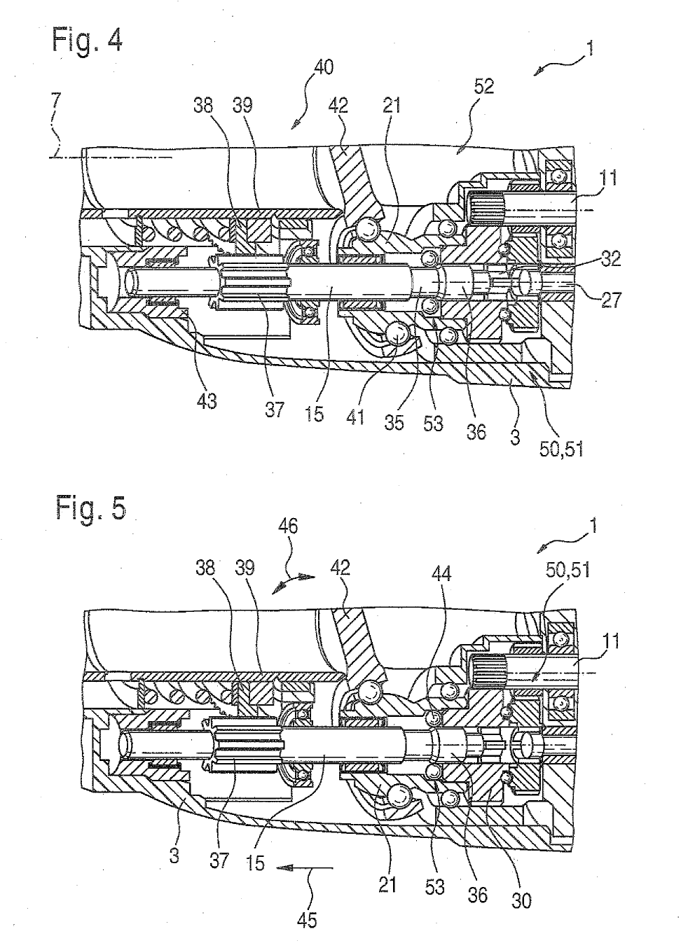

FIGS. 3 through 7 depict an inner region of the rotary and/or percussion hammer 2 from FIG. 1. An electric drive motor, not shown, has a motor shaft 11 on which a pinion 12 is supported in a rotationally fixed fashion. In addition, the end region 13 of the motor shaft 11 is provided with a spur gearing 14. The electric drive motor that is not shown drives the motor shaft 11 around the rotary axis 9.

Below the motor shaft 11, an intermediate shaft 15 with a rotation axis 16 parallel to the rotation axis 9 is supported in a rotatable, but axially movable fashion (double arrow 17) in the housing 3 of the electric hand tool 1. The bearing 19 is provided for supporting the one end of the intermediate shaft 15. In addition, a ball bearing 20 supports a rotating part 21 of an impact mechanism drive unit 22; the rotating part 21 has a slide bearing 23 that encompasses the intermediate shaft 15. An intermediate flange 24 of the housing 3 of the electric hand tool 1 has a ball bearing 25 for supporting the intermediate shaft 15. A ball bearing 26 supports the motor shaft 11 in a rotatable, axially fixed fashion.

An axial stem 27 of a spur gear 28 is supported in a housing bearing 18 around the rotation axis 16; by means of a ball bearing 29, the spur gear 28 supports another spur gear 30 in rotating fashion around the rotation axis 16 and this spur gear 30 extends with an axial extension 31 to the slide bearing 23. The spur gear 28 meshes with the pinion 12 and the spur gear 30 meshes with the spur gearing 14 of the motor shaft 11.

The intermediate shaft 15 has a driver profile 32 at one end 31′, which can cooperate with counterpart driver profiles 33, 34 of the spur gear 28 and spur gear 30, depending on the axial position of the intermediate shaft 15, as a result of which the spur gear 28 for the spur gear 30 produces a rotary drive of the intermediate shaft 15.

The intermediate shaft 15 has a smaller diameter collar region 35 and a larger diameter collar region 36; the arrangement of these is selected so that—viewed in the longitudinal direction of the intermediate shaft 15—the driver profile 32 is provided first, followed by the larger diameter collar region 36 and then the smaller diameter collar region 35. On the other side of the ball bearing 25, the intermediate shaft 15 has a pinion 37 that meshes with a ring gear 38 that is attached in a rotationally fixed fashion to a hammer tube 39 of an impact mechanism 40. The hammer tube 39 is supported so that it is able to rotate around the rotation axis 7 and drives the tool socket 8 along with it in a rotationally fixed fashion.

The impact mechanism drive unit 22 includes a ball bearing 41 that is inclined in relation to the rotation axis 16 and supports a swiveling lever 42 on the rotating part 21. The swiveling lever 42 is connected in a movable, swiveling fashion to a piston, not shown, which is moved back and forth inside the hammer tube 39 with a swiveling motion of the swiveling lever 42 in order to produce an air cushion that acts on a header, which is situated in the hammer tube 39 and in turn acts on an impact pin in order to exert a percussive action on a tool clamped into the tool socket 8. The bearing 19 is associated with a rotation lock 43, which—in the corresponding axial position of the intermediate shaft 15—locks the pinion 37 and therefore the intermediate shaft 15, preventing them from rotating.

The pinion 12, the spur gearing 14, the spur gear 28, and the spur gear 30 form a transmission 50, in particular a multistage spur gear transmission 51. The transmission 50 is part of a transmission/clutch unit 52 that is equipped with additional clutch components in the form of the driver profile 32 and the counterpart driver profiles 33 and 34 as well as driver balls 44 and corresponding catch regions in the rotating part 21. The driver balls 44 will be discussed in greater detail below. The driver balls 44 cooperate with corresponding catch regions of the rotating part 21 to form a rotary drive coupling 53.

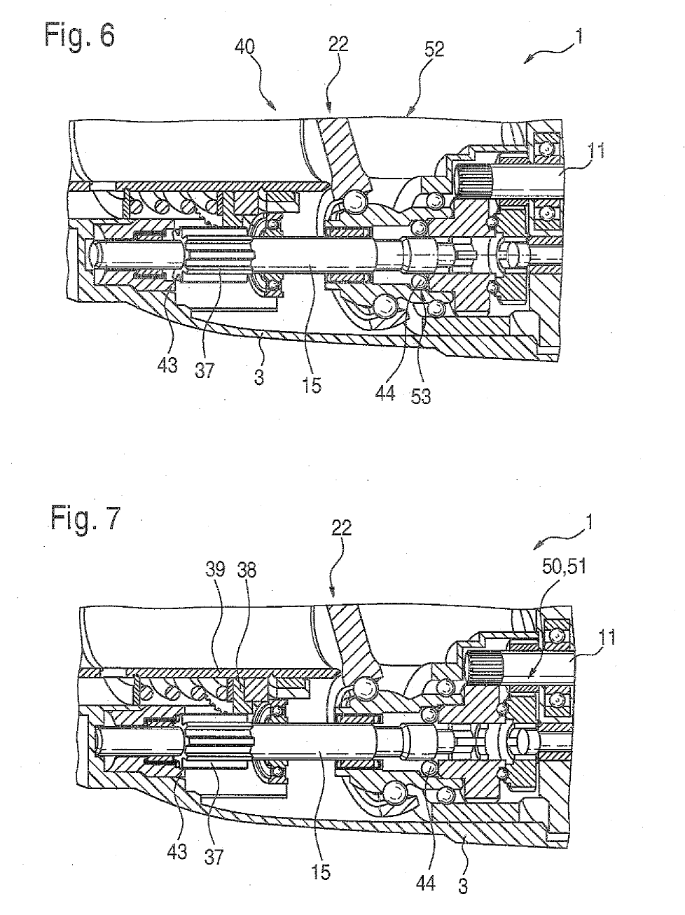

The function of the electric hand tool 1 in five different operating modes, which can be selected by means of the operating mode selector switch 10, will be explained below in conjunction with FIGS. 4 through 7.

If the operating mode selector switch 10 is rotated, this causes a corresponding axial movement of the intermediate shaft 15; the force transmission between the operating mode selector switch 10 and the intermediate shaft 15 (e.g. the rack and pinion principle) is not shown in detail. If the intermediate shaft 15 is in the position shown in FIG. 3, then the driver profile 32 and the counterpart driver profile 33 of the spur gear 28 are coupled. The spur gear 30 is not connected to the intermediate shaft 15 in a rotationally fixed fashion. As a result, a rotation of the motor shaft 11 through an operation of the drive motor causes both the pinion 12 and the spur gearing 14 to rotate and as a result, the two spur gears 28 and 30 are driven at different speeds as a result of their different diameters; the spur gear 30, however, simply rotates on the intermediate shaft 15, but does not execute any driving action; instead, the spur gear 28 rotates the intermediate shaft 15 with a correspondingly fast gear, i.e. at a correspondingly high speed. Driver balls 44 that are supported in the corresponding recesses of the axial extension 31 of the spur gear 30 rest in the smaller diameter collar region 35 of the intermediate shaft 15 and therefore do not exert any driving action on corresponding catch regions of the rotating part 21 as a result of which the impact mechanism drive unit 22 is not operational. The driver balls 44 cooperate with the catch regions to form the rotary drive coupling 53. The intermediate shaft 15, which rotates at a corresponding speed, acts via the pinion 37 and the ring gear 38 to drive the hammer tube 39 and therefore the tool socket 8. This produces a drilling operation at a high speed.

If the operating mode selector switch 10 is used to produce an axial position of the intermediate shaft 15 show in FIG. 4, then the driver profile 32 of the intermediate shaft 15 disengages from the counterpart driver profile 33 of the spur gear 28 and engages with the counterpart driver profile 34 of the spur gear 30. As a result, the drive motor, as it rotates the motor shaft 11, transmits torque via the spur gearing 14 and the spur gear 30 and therefore to the intermediate shaft 15; because the spur gear 30 has a larger diameter than the spur gear 28, the intermediate shaft 15 rotates at a lower speed. The motor shaft 15 does in fact drive spur gear 28 via the pinion 12, but this does not result in a driving action on the intermediate shaft 15 because of the above-mentioned disengagement. There is no other difference from the state shown in FIG. 3, consequently resulting in a drive (pure drilling drive) of the tool socket 8 with a slower gear, i.e. at a lower speed.

If the operating mode selector switch 10 is used to move the intermediate shaft 15 even farther in the direction of the arrow 45, then this results in the situation shown in FIG. 5. This corresponds to a percussion drilling operation at a speed that has been established in FIG. 4. The speed is maintained because of the coupling of the motor shaft 11 via the spur gear 30; but the larger diameter collar region 36 displaces the driver balls 44 outward, causing them to engage in a driving fashion behind a corresponding formation of the rotating part 21, i.e. the intermediate shaft 15 drives the rotating part 21, causing the swiveling lever 42 to be set into a reciprocating motion indicated by the double arrow 46. This causes the piston situated in the hammer tube 39 to moved back and forth, producing an air cushion that acts on the header therefore on the tool, causing the tool to carry out a percussive movement. It is simultaneously rotated since the hammer tube 39 is in fact set into a rotating motion via the pinion 37 and the ring gear 38.

If the operating mode selector switch 10 is used to move the intermediate shaft 15 farther in the direction of the arrow 45, then this results in the situation shown in FIG. 6, the so-called Vario-Lock mode, which permits the hammer tube 39 and therefore the tool inserted into it, to be positioned for chiseling. The intermediate shaft 15 is axially positioned so that there is no longer a rotating driving action with the spur gear 30; however, because the driver balls 44 are displaced radially outward, the impact mechanism drive unit 22 is still coupled to the intermediate shaft 15, but the pinion 37 no longer engages with the rotation lock 43. The user can then independently establish the rotation angle position of the insert tool. This is done with the drive motor switched off. A manual rotation of the insert tool leads to a corresponding rotation of the hammer tube 39 and, via the ring gear 38 and the pinion 37, leads to a rotation of the intermediate shaft 15.

If corresponding actuation of the operating mode selector switch 10 is used to move the intermediate shaft 15 even farther in the direction of the arrow 45—shown in FIG. 7—then the teeth of the pinion 37 engage in corresponding housing recesses of the rotation lock 43 at the end, which prevents the intermediate shaft 15 from rotating. As a result, the insert tool remains in the desired rotation position. If the drive motor is then set into operation, the motor shaft 11, acting via the spur gearing 14, rotates the spur gear 30 and therefore also its axial extension 31, which, acting via the driver balls 44, rotates the rotating part 21, thus activating the impact mechanism drive unit 22, i.e. causing the impact mechanism 40 to function. Since the intermediate shaft 15 is rotationally disengaged from both of the spur gears 28 and 30, no rotary motion of the tool is carried out, yielding a pure chiseling operation.

1-6. (canceled)

7. An electric hand tool embodied in the form of a rotary and/or percussion hammer, comprising:
a working spindle;
an impact mechanism;
an electric drive motor;
a transmission/clutch unit connected to the drive motor which includes a transmission;
an intermediate shaft connected to the transmission/clutch unit; and
an impact mechanism drive unit driven by the intermediate shaft which thereby drives the working spindle, wherein the transmission is a multistage spur gear transmission, having gears which are switched through axial movement of the intermediate shaft.

8. The electric hand tool as recited in claim 7, wherein the intermediate shaft is associated with at least two different-diameter spur gears of the spur gear transmission so that the spur gears maintain their axial position during the axial movement of the intermediate shaft.

9. The electric hand tool as recited in claim 8, wherein the intermediate shaft has a driver profile that in different axial positions of the intermediate shaft, is coupled in a rotationally fixed fashion to a respective counterpart driver profile of one or an other of the two spur gears or is coupled to neither of the spur gears.

10. The electric hand tool as recited in claim 7, further comprising a rotary drive coupling of the intermediate shaft and the impact mechanism drive unit, which coupling couples or uncouples as a function of the axial position of the intermediate shaft.

11. The electric hand tool as recited in claim 8, further comprising a rotary drive coupling of the intermediate shaft and the impact mechanism drive unit, which coupling couples or uncouples as a function of the axial position of the intermediate shaft.

12. The electric hand tool as recited in claim 9, further comprising a rotary drive coupling of the intermediate shaft and the impact mechanism drive unit, which coupling couples or uncouples as a function of the axial position of the intermediate shaft.

13. The electric hand tool as recited in claim 7, further comprising a rotation lock of the intermediate shaft, which locks the intermediate shaft in a corresponding axial position, thereby preventing the intermediate from rotating.

15. The electric hand tool as recited in claim 8, further comprising a rotation lock of the intermediate shaft, which locks the intermediate shaft in a corresponding axial position, thereby preventing the intermediate from rotating.

16. The electric hand tool as recited in claim 9, further comprising a rotation lock of the intermediate shaft, which locks the intermediate shaft in a corresponding axial position, thereby preventing the intermediate from rotating.

17. The electric hand tool as recited in claim 10, further comprising a rotation lock of the intermediate shaft, which locks the intermediate shaft in a corresponding axial position, thereby preventing the intermediate from rotating.

18. The electric hand tool as recited in claim 7, embodied in a pistol design in which a drive shaft of the drive motor is situated extending parallel to the working spindle.

19. The electric hand tool as recited in claim 8, embodied in a pistol design in which a drive shaft of the drive motor is situated extending parallel to the working spindle.

21. The electric hand tool as recited in claim 9, embodied in a pistol design in which a drive shaft of the drive motor is situated extending parallel to the working spindle.

21. The electric hand tool as recited in claim 10, embodied in a pistol design in which a drive shaft of the drive motor is situated extending parallel to the working spindle.

22. The electric hand tool as recited in claim 11, embodied in a pistol design in which a drive shaft of the drive motor is situated extending parallel to the working spindle.
